(19) United States
(12) Patent Application Publication
(10) Pub. No.: US 2020/0184853 A1
(43) Pub. Date: Jun. 11, 2020

(54) WRISTBAND WITH NEPHROID SHAPED HOLES

(71) Applicant: Artemax, Inc., Brookfield, WI (US)

(72) Inventors: Bethany Schmid, Muskego, WI (US); Bryan Waltersdorf, Oconomowoc, WI (US)

(21) Appl. No.: 16/212,361

(22) Filed: Dec. 6, 2018

(51) Int. Cl. G09F 3/00; G09F 3/16

(52) U.S. Cl. CPC G09F 3/005; G09F 3/16

(57) ABSTRACT

A wristband assembly comprising a strip of material having two ends, a closure hole adjacent one end, and a nephroid-shaped hole spaced from the closure hole, and a snap closure including a securing portion positioned through both the closure hole and the nephroid-shaped hole to hold the strip of material in a loop. In one embodiment, there are a plurality of nephroid-shaped holes, and each nephroid-shaped holed defines a major axis that is substantially perpendicular to a longitudinal axis of the strip of material. Preferably, the nephroid-shaped hole comprises a first lobe adjacent a first side edge of the strip of material and a second lobe adjacent a second side edge of the strip of material. In this embodiment, the snap closure further includes a hinge adjacent the first side edge, and the securing portion is positioned in the first lobe of the nephroid-shaped hole.

### BACKGROUND

The present invention relates to wristbands, such as wristbands used for identification.

Wristbands are commonly used for identification purposes, such as for indicating that a person is authorized to enter a certain area. Such wristbands are commonly made of a thin, flexible material, such as spun-bonded plastic, and are held in a looped configuration around the person's wrist or ankle by a snap closure. The snap closure includes a post that is positioned through two aligned openings in the wristband to hold the wristband in a loop.

### SUMMARY

The present invention provides a wristband assembly comprising a strip of material and a snap closure. The strip of material has two ends, a closure hole adjacent one end, and a nephroid-shaped hole spaced from the closure hole. The nephroid-shaped holes create superior breathability which increases the overall comfort when wearing the wristbands. The unique shaped holes also improve band flexibility creating more comfort. The snap closure includes a securing portion (e.g., a post) positioned through both the closure hole and the nephroid-shaped hole to hold the strip of material in a loop. Preferably, the strip of material defines a longitudinal axis, and the nephroid-shaped hole defines a major axis that is substantially perpendicular to the longitudinal axis. The assembly can include a plurality of nephroid-shaped holes spaced from each other along a longitudinal extent of the strip of material, and the securing portion can be positioned in one half of one of the nephroid-shaped holes. For example, the nephroid-shaped holes can comprise a first lobe adjacent a first side edge of the strip of material and a second lobe adjacent a second side edge of the strip of material, and the snap closure can includes a hinge adjacent the first side edge with the securing portion positioned in the first lobe of the nephroid-shaped hole.

Other aspects of the invention will become apparent by consideration of the detailed description and accompanying drawings.

### BRIEF DESCRIPTION OF THE DRAWINGS

FIG. 1 is a perspective view of a wristband assembly embodying the present invention in the process of being wrapped around a person's wrist.

FIG. 2 is a top view of the wristband of FIG. 1.

FIG. 3 is an enlarged view of one end of the wristband with a snap closure in an open position.

FIG. 4 is an enlarged view of a middle portion of the wristband with the snap closure in the open position.

FIG. 5 is an enlarged view of the wristband assembly with the snap closure in a closed position and retaining the wristband in a loop.

FIG. 6 is an enlarged view of nephroid-shaped holes in the wristband.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

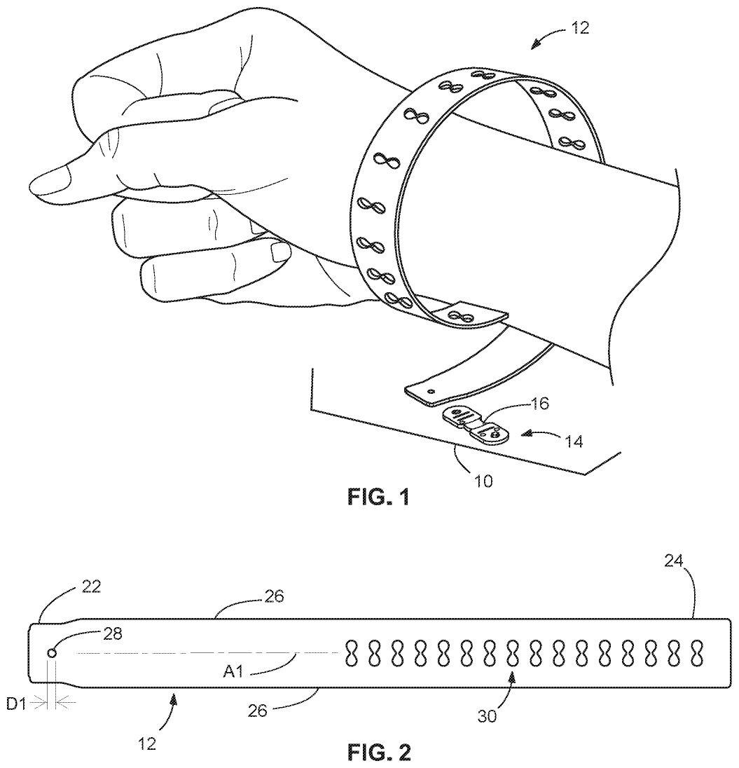

FIG. 1 illustrates a wristband assembly 10 comprising a wristband in the form of a strip of material 12, and a snap closure 14. The illustrated strip of material 12 comprises a direct thermal paper, but the strip of material could instead comprise any appropriate material, such as spun-bonded plastic, silicone, plastic, cloth, or vinyl.

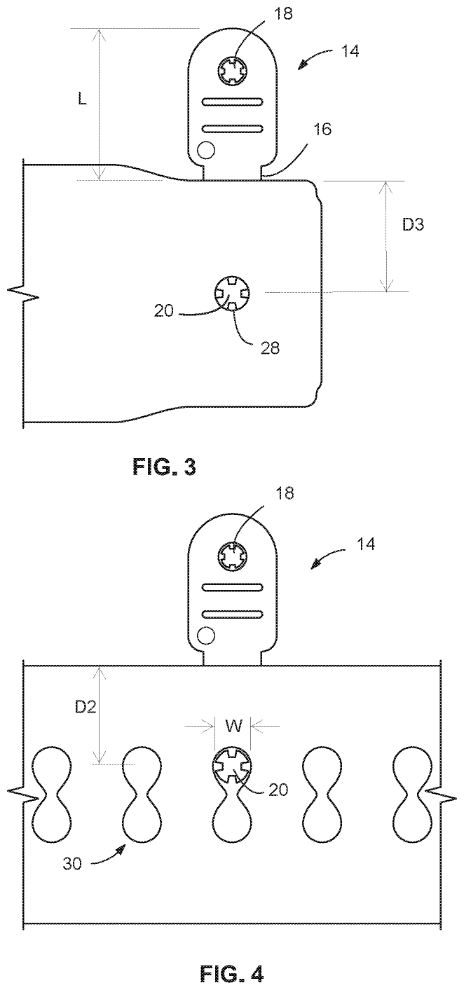

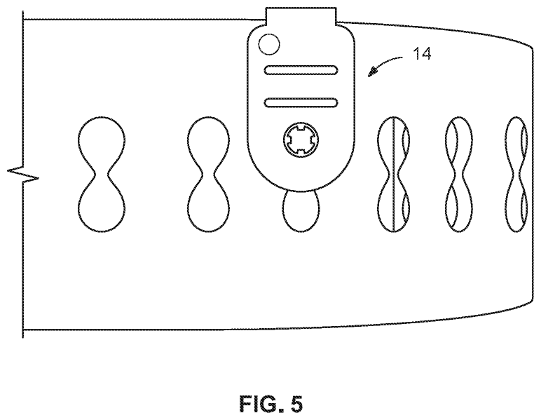

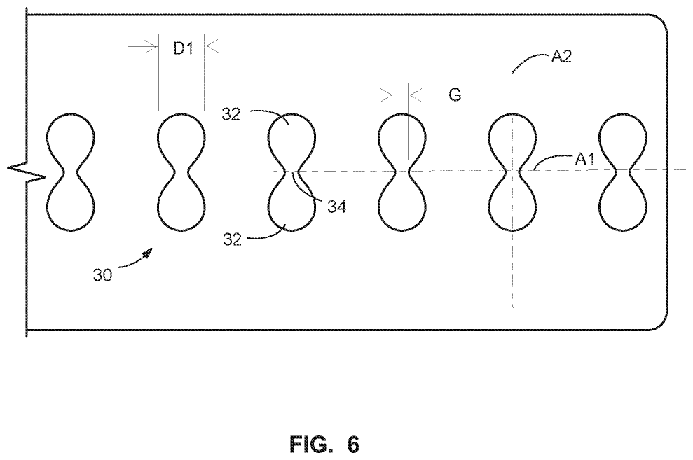

The snap closure 14 comprises a molded plastic piece having a living hinge 16, a receptacle 18, and a securing portion in the form of a post 20 designed to be inserted through holes in the strip of material 12 and snapped into the receptacle 18 to hold the strip of material 12 in a loop. Specifically, the snap closure 14 can be bent at the living hinge 16 from an open position (FIGS. 3-4) to a closed position (FIG. 5) in which the post 20 is snapped into the receptacle 18. The post 20 and receptacle 18 have a one-way relationship that inhibits removal of the post 20 from the receptacle 18, as is known in the art. When in the closed position, the illustrated snap closure 14 has a closure length L of about 0.49 inch between the inside edge of the hinge 16 and the center of the post 20.

The strip of material 12 comprises two ends 22,24 and two side edges 26 that cooperatively define a longitudinal axis A1 of the strip of material 12. The strip of material 12 further includes a closure hole 28 on one end 22 and a plurality of nephroid-shaped holes 30 spaced from the closure hole 28. As used herein, “nephroid-shaped hole” means a hole having at least two lobes 32 separated by a narrowed portion 34 (see FIG. 6). The illustrated lobes 32 are each of similar size and have a generally round shaped for receiving the post 20 of the snap closure 14. But it should be understood that the lobes 32 can be a variety of different shapes, such as triangular, oval, square, etc. The narrowed portion 34 defines a gap G that is substantially smaller than the width W of the post 20, as shown in FIG. 4, thereby retaining the post 20 in one of the lobes 32 and inhibiting the post 20 from sliding into the other lobe 32 of the same nephroid-shaped hole 30. The nephroid shaped holes create superior breathability which increases the overall comfort when wearing the wristbands. The unique shaped holes also improve band flexibility creating more comfort. The holes also retain the post 20 in a relatively static position relative to the lobes 32 to thereby limit relative lateral sliding movement between the overlapped portions of the strip of material 12, which is believed to enhance comfort to the user.

In the illustrated embodiment, each of the center hole 28 and the lobes 32 of the nephroid-shaped holes 30 has a diameter D1 of 0.125 inch. The center of each lobe 32 is spaced from the closest side edge 22,24 of the strip of material 12 by a distance D2 of 0.4375 inch. The center of the center hole 28 is spaced from the nearest side edge 22,24 by a distance D3 of about 0.48 inch.

Each illustrated nephroid-shaped hole 30 defines a major axis A2 extending through the center of the lobes 32 and between the narrowed portion 34. The illustrated major axis A2 is perpendicular to the longitudinal axis A1 of the strip of material 12. In this regard, each lobe 32 of each nephroid-shaped hole 30 is positioned adjacent one of the side edges 22,24 of the strip of material 12.

Referring to FIG. 5, it is noted that the snap closure 14 is dimensioned such that the closure length L is about the same as or only slightly larger than the distance D2 from the side edge 22,24 to the center of the closest lobe 32. In this regard, when snapped into the closition position on the strip of material 12, the snap closure 14 is held relatively snugly in position on the strip of material 12 and substantially prevent from moving relative to the strip of material 12.

Various features and advantages of the invention are set forth in the following claims.

1. A wristband assembly comprising:
a strip of material having two ends, a closure hole adjacent one end, and a nephroid-shaped hole spaced from the closure hole; and
a snap closure including a securing portion positioned through both the closure hole and the nephroid-shaped hole to hold the strip of material in a loop.

2. A wristband assembly as claimed in claim 1, wherein the strip of material defines a longitudinal axis, and wherein the nephroid-shaped hole defines a major axis that is substantially perpendicular to the longitudinal axis.

3. A wristband assembly as claimed in claim 1, wherein the nephroid-shaped hole comprises a plurality of nephroid-shaped holes spaced from each other along a longitudinal extent of the strip of material, and the securing portion is positioned in one of the nephroid-shaped holes.

4. A wristband assembly as claimed in claim 1, wherein the securing portion is positioned in one half of the nephroid-shaped hole.

5. A wristband assembly as claimed in claim 1, wherein the snap closure further includes a hinge adjacent one side edge of the strip of material.

6. A wristband assembly as claimed in claim 1, wherein the nephroid-shaped hole comprises a first lobe adjacent a first side edge of the strip of material and a second lobe adjacent a second side edge of the strip of material, wherein the snap closure further includes a hinge adjacent the first side edge, and wherein the securing portion is positioned in the first lobe of the nephroid-shaped hole.

7. A wristband comprising a strip of material having two ends, a closure hole adjacent one end and a nephroid-shaped hole spaced from the closure hole.

8. A wristband as claimed in claim 7, wherein the strip of material defines a longitudinal axis, and wherein the nephroid-shaped hole defines a major axis that is substantially perpendicular to the longitudinal axis.

9. A wristband as claimed in claim 7, wherein the nephroid-shaped hole comprises a plurality of nephroid-shaped holes spaced from each other along a longitudinal extent of the strip of material.

10. A wristband as claimed in claim 7, wherein the nephroid-shaped hole comprises a first lobe adjacent a first side edge of the strip of material and a second lobe adjacent a second side edge of the strip of material.
